(19) United States
(12) Patent Application Publication
(10) Pub. No.: US 2004/0255265 A1
(43) Pub. Date: Dec. 16, 2004

(54) System and method for project management

(76) Inventors: William M. Brown, Dallas, TX (US); Joseph A. Marquez, Carrollton, TX (US); Ronnie C. Murray, Arlington, TX (US)

Correspondence Address: Philip G. Meyers Law Office, Suite 302, 1009 Long Prairie Road, Flower Mound, TX, 75022, US

(21) Appl. No.: 10/811,478

(22) Filed: Mar. 26, 2004

Related U.S. Application Data
(60) Provisional application No. 60/457,887, filed on Mar. 26, 2003.

(51) Int. Cl. G06F 9/44

(52) U.S. Cl. 717/101; 717/105

(57) ABSTRACT

The invention provides a method for computer-implemented management of a project using project management software. The project is defined by a series of development phases wherein each development phase of the project must be evaluated by one or more predetermined standards. Each of the standards defines a set of quality assurance steps to be followed in order to achieve compliance with the standard for each phase. Such a method includes the steps of selecting one of the development phases, displaying a reporting screen containing reporting instructions for the selected development phase, which instructions relate to compliance with the quality assurance steps for that phase according to at least one of the standards, inputting reporting information concerning the selected development phase, and saving the reported information concerning the selected development phase. The instructions on the reporting screen will usually ask if one or more documents relating to compliance with one or more of the quality assurance steps for that phase were completed. The step of saving the reporting information may comprise printing it out, transmitting it to a recipient such as a quality assurance entity, or saving it to a data storage medium for later access.

This application claims priority of U.S. Provisional Application No. 60/457,887, filed Mar. 26, 2003, the entire contents of which are incorporated by reference herein.

### INCORPORATED MATERIALS

This application hereby incorporates by reference herein the accompanying computer program listing appendix submitted on a two compact disks labeled COPY1 and COPY2 each containing the following files:

| Creation Date/Time | Size in Bytes | File Name |
|---|---|---|
| Mar. 18, 2004 03:40 PM | 23,055 | ACarc.cgi |
| Mar. 18, 2004 03:40 PM | 4,169 | AcarcList.cgi |
| Mar. 18, 2004 03:40 PM | 26,000 | buildGraphic.cgi |
| Mar. 18, 2004 03:40 PM | 35,000 | EDP.cgi |
| Mar. 18, 2004 03:40 PM | 22,000 | EDP_Milestone.cgi |
| Mar. 18, 2004 03:40 PM | 11,000 | EDP_MS_editor.cgi |
| Mar. 18, 2004 03:40 PM | 6,000 | EDP_MS_Q_dump.cgi |
| Mar. 18, 2004 03:40 PM | 7,000 | EDP_MS_rollup.cgi |
| Mar. 18, 2004 03:40 PM | 19,000 | EDP_PR.cgi |
| Mar. 18, 2004 03:40 PM | 23,000 | EDP_Pri_Add.cgi |
| Mar. 18, 2004 03:40 PM | 33,000 | EDP_SQAP.cgi |
| Mar. 18, 2004 03:40 PM | 14,000 | EDPeditor.cgi |
| Mar. 18, 2004 03:40 PM | 6,000 | EDPinput.cgi |
| Mar. 18, 2004 03:40 PM | 18,000 | EDPnewReq.cgi |
| Mar. 18, 2004 03:40 PM | 74,000 | EPR_v2.0.cgi |
| Mar. 18, 2004 03:43 PM | 2,000 | Excel.cgi |
| Mar. 18, 2004 03:43 PM | 7,000 | ExcelSQL.cgi |
| Mar. 18, 2004 03:43 PM | 6,000 | Gemini_3.0.cgi |
| Mar. 18, 2004 03:40 PM | 3,000 | Gemini_3.0_dd.cgi |
| Mar. 18, 2004 03:40 PM | 23,049 | Geminiarc.cgi |
| Mar. 18, 2004 03:40 PM | 5,000 | GeminiList.cgi |
| Mar. 19, 2004 05:58 AM | 3,782 | GeminiPatent.sql |
| Mar. 18, 2004 03:40 PM | 6,000 | OnDemand.cgi |
| Mar. 18, 2004 03:40 PM | 10,290 | PM_Milestone.cgi |
| Mar. 18, 2004 03:40 PM | 10,182 | Proj_MS_Tracking.cgi |
| Mar. 18, 2004 03:40 PM | 23,000 | Samplearc.cgi |
| Mar. 18, 2004 03:40 PM | 5,000 | Samplelist.cgi |
| Mar. 18, 2004 03:40 PM | 13,320 | SDP_Milestone.cgi |
| Mar. 18, 2004 03:40 PM | 4,697 | SDP_MS_Tracking.cgi |
| Mar. 18, 2004 03:40 PM | 14,041 | SDP_PR.cgi |
| Mar. 18, 2004 03:40 PM | 30,814 | SDP_SQAP.cgi |
| Mar. 18, 2004 03:40 PM | 23,000 | SDPcgi.cgi |
| Mar. 18, 2004 03:40 PM | 10,000 | SDPdump.cgi |
| Mar. 18, 2004 03:40 PM | 10,000 | SDPeditor.cgi |
| Mar. 18, 2004 03:40 PM | 5,000 | SDPinput.cgi |
| Mar. 18, 2004 03:40 PM | 8,000 | SQAP_3.0.cgi |
| Mar. 18, 2004 03:40 PM | 5,097 | SQLform.cgi |

The foregoing files were written for mysql-3.23.52-pc-linux-gnu-i1686. These file extensions (.cgi and .sql) are ASCII text files. The system is referred to by the name “Gemini”.

### TECHNICAL FIELD

The invention relates to a system and method for project management, and in particular, a network based system for recording and monitoring compliance with a combination of internal and external standards.

### BACKGROUND OF THE INVENTION

In the current business environment, effective project management is a key factor in the success of many enterprises. Large projects involving the design and development of a new product, the completion of a facility or the modification of an existing product or facility typically involve the expertise of different engineering disciplines and a diverse range of personnel. To manage complex projects, businesses typically utilize internally developed controls, policies, protocols and systems that divide projects into stages or phases. Associated with each phase are given tasks and activities. Completion of the tasks and activities are recorded by project personnel upon completion, as well as “milestones” indicating the completion of all tasks and activities associated with the phase or assigned to a particular discipline in connection with the phase. These project management methods, typically carried out manually, provide a means of monitoring and controlling the project. Of course, different businesses in different industries as will as businesses within a given industry will use different project management systems and tools that are tailored to the businesses' size, management structure, business plan, philosophy and objectives.

Compliance with internal project management systems and policies is rarely sufficient to meet the demands of the marketplace. In today's business environment, compliance with external standards, quality assurance programs and protocols must often be demonstrated to customers, potential customers and entities that create and certify compliance with the standards. In some cases, compliance with multiple standards and protocols must be demonstrated in connection with a single project. Many times these external standards and protocols do not readily match internal project management systems and tools. Thus, personnel involved with a project may be presented with the daunting task of ensuring compliance with not only internal project management systems and policies, but also with externally imposed standards and protocols.

### SUMMARY OF THE INVENTION

The invention provides a method for computer-implemented management of a project using project management software. The project is defined by a series of development phases wherein each development phase of the project must be evaluated by one or more predetermined standards. Each of the standards defines a set of quality assurance steps to be followed in each phase in order to achieve compliance with the standard. In basic form, such a method includes the steps of selecting one of the development phases, displaying a reporting screen containing reporting instructions for the selected development phase, which instructions relate to compliance with the quality assurance steps for that phase according to at least one of the standards, inputting reporting information concerning the selected development phase, and saving the reported information concerning the selected development phase. The instructions on the reporting screen will usually ask if one or more documents relating to compliance with one or more of the quality assurance steps for that phase were completed. The step of saving the reporting information may comprise printing it out, transmitting it to a recipient such as a quality assurance entity, or saving it to a data storage medium for later access.

In a preferred form of the invention, each user of the system performing the foregoing steps can select a user role and then display a description of what a user having that role should do during the selected phase for each quality assurance step to comply with one of the predetermined standards. The displayed description may be composite instructions meeting two or more predetermined standards, such as ISO and CMM standards. In this manner the system can ensure that both external standards are complied with in a single set of reports or activities. The description lists one or more documents required to be completed to satisfy a quality assurance step for the selected development phase, preferably as a table having separate entries for: planning activities preceding the project phase, phase inputs, phase outputs, peer reviews, verification results, validation results, and procedures for handling changes made during the phase.

According to a further aspect of the invention, a milestone data file containing target completion dates for each phase of the project is stored on a data storage medium. The project management system includes program logic that can graphically display the phases completed, phases not yet completed and past target completion date, and phases not yet completed not yet past target completion date.

The invention further provides a computer-implemented system for management of a project as defined above. Such as system includes a host computer, a database stored on permanent data storage media accessible to the host computer, the database having discrete records containing information concerning state of completion of the project, and the project management software executable on the host computer. The system further preferably includes a network interface whereby users can remotely access the project management software through a network. The database preferably contains a milestone file of indicators, which keep track of completion of development phases, and a schedule file containing target completion dates for each phase of the project. These and other aspects of the invention are more fully discussed in the description that follows.

### BRIEF DESCRIPTION OF THE DRAWINGS

In the accompanying drawings:

FIG. 1 is a flow diagram comparing a strategic plan, a development plan, and a series of quality assurance steps to be executed within each phase of the development plan;

FIG. 2 is a schematic diagram of a system according to the invention; and

FIGS. 3-9 are flowcharts illustrating system functions according to the invention.

### DETAILED DESCRIPTION OF THE INVENTION

According to the invention, a “strategic plan” is a model series of phases for a project. In practice, the model or standard phases of a strategic plan of this nature may not coincide exactly with the actual phases of the project, which are usually more specifically defined and greater in number than the phases of the strategic plan. Accordingly, it is useful in setting up a project for use with the method of the invention to create a series of development phases, which can be mapped onto the phases of the strategic plan, so that compliance with the strategic plan can be readily demonstrated. Thus, the development phases of a project are user- or system-defined, whereas the strategic plan phases are an ideal that does not change from one project to the next, or for different types of projects. In the example below, a single generic twelve-phase template of development phases is used for all projects, but different user defined sets of development phases could be used. Quality assurance steps” are the steps to be executed for each development phase. These are preferably dictated by one or more external standards as discussed below.

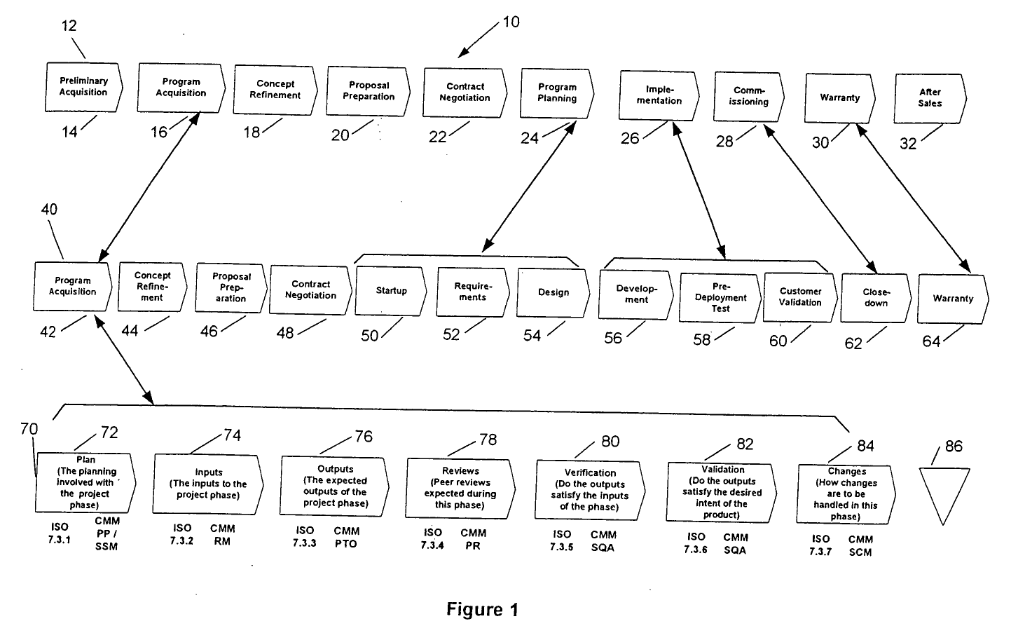

Referring now to FIG. 1, there is shown an exemplary schematic representation of a project management plan 10 utilizing the project management system and method of the invention. As shown, row 12 identifies an internal program management process model or other strategic plan comprising a sequence of project stages 14-32. The internal program process model or strategic plan represented by steps 14-32 comprises a project management model or protocol used to monitor and manage projects from step 14, preliminary acquisition through step 32, after-sales activities.

Row 40 comprises a series of generic development phases 42-64 through which a typical project progresses. Development phases 42 through 64 in row 40 may be associated with or mapped to a corresponding stage in row 12. As shown, program planning stage 24 corresponds to three phases (startup 50, requirements 52, design 54) of the actual project. While development phases 42-64 are illustrated in a generic form, it will be appreciated that the phases may be varied in connection with a particular project.

Row 70 represents a series of sub-phases or quality assurance steps 72-84 for each development phase identified in row 40, ending in a step 86 milestone process assurance activity. Each of the quality assurance steps or activities identified in row 70 corresponds to one or more external standards or protocols, for example the requirements of IS09001:2000 and the KPAs (Key Process Areas) of CMM (Capability Maturity Model). In the steps shown, steps 72-84 correspond to ISO clauses 7.3.1-7.3.7 respectively and to the corresponding CMM requirements listed. Verification is a comparison by the developer of the outputs to the original inputs, whereas validation is an evaluation by the customer that the finished product meets the customer's needs. For example, stage 16 of row 12 may be associated with development phase 42 of row 40, which in turn entails the completion of the quality assurance steps identified in row 70. Different engineering and other disciplines will have different tasks and responsibilities in connection with the development phases, tasks and activities represented in FIG. 1. Similarly, individuals at different management levels will have varying degrees of responsibility for completion of the tasks and activities represented in FIG. 1.

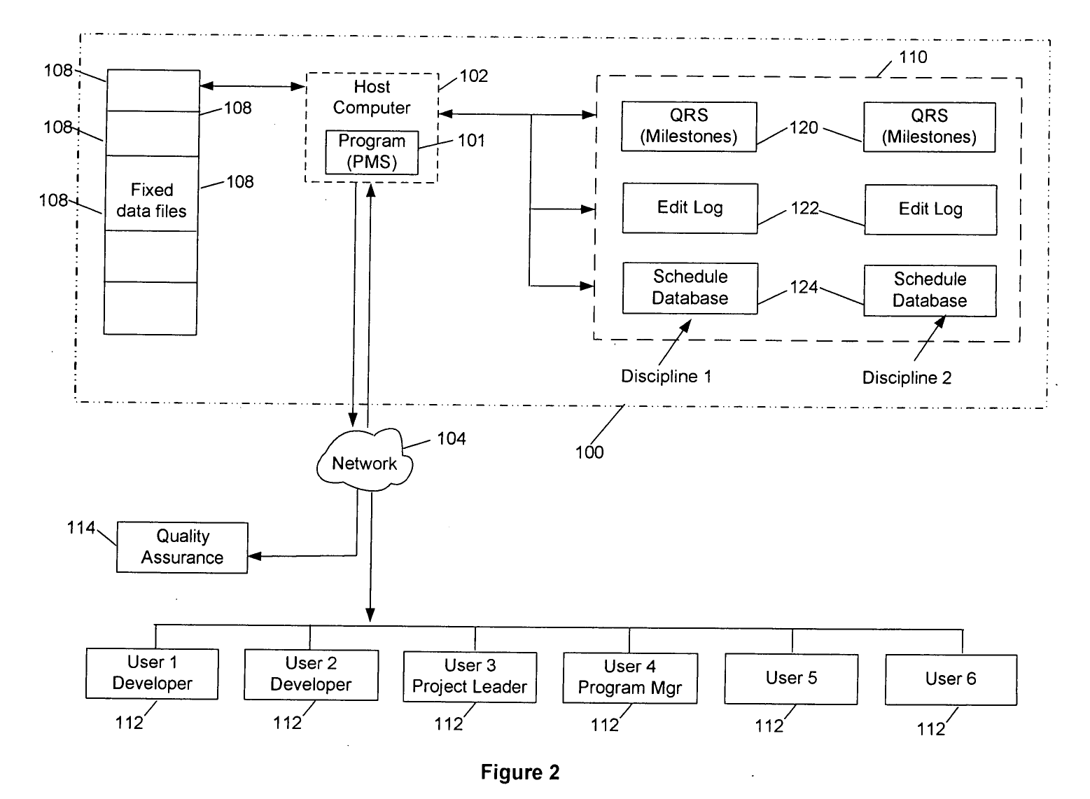

Turning now to FIG. 2, one system 100 according to the invention includes a host computer 102 linked to a network 104 via a network interface. Resident on host computer 102 is the project management software (PMS) 101 that implements the system and method of the invention. Host computer 102 is linked to an internal or external permanent data storage device for storing fixed data files 108 and variable data files 110 associated with a given project. Network 104, such as a LAN, WAN or the Internet, provides a link with a plurality of terminals or computers 112 that provide a means for users of system 100 to update and edit information in variable data files 110 and generate reports. A set of variable data files 110 are maintained for each engineering discipline involved in the project. Network 104 also provides a link to the quality assurance department 114 where forms and/or reports are sent to be reviewed and printed. Fixed data files 108 include descriptions of quality assurance steps associated with each development phase 42-64, and all of the other content and text accessed by the system as set forth in the computer program listing appendix.

Table 1 presents a sample listing of quality assurance steps 72-84 in a development phase 42 for the software engineering discipline in a SOW (statement of work) project type. As shown, the tasks are organized by position, e.g., developer, engineering project manager, program manager project lead and line manager. A corresponding set of quality assurance task descriptions will exist for each phase and each discipline involved in a project type. The project management software accesses this table and selects a line from the table that is used as the text in the quality assurance steps discussed below:

TABLE 1

| id Source | Plan | Inputs | Outputs | Reviews |
|---|---|---|---|---|
| 11 EPM/ | The planning for this phase includes | The inputs for this phase are | The output to this phase is | The EPMs and TPMs |
| TPM | considerations made for the coordination of | the contracted work needing | that the requirements are | participate in the Concurrent |
| | engineering work | to be mapped to | mapped out in the | Engineering Meetings. |
| | | requirements. | requirements documents. | |
| 13 Process | The planning for this phase includes | The inputs to the phase | Outputs to the phase include | Review for this phase are that |
| Assurance | monitoring the project against the | include the completed | the Process Assurance team | the Process Assurance team is |
| | Planning documents to ensure compliance | Planning documents. | reviewed and approved RTM | to monitor and review |
| | to the submitted plan. | | and SRD. | incoming Milestone |
| | | | | completion notifications for |
| | | | | content and compliance. |
| 32 EPM | The planning for this phase includes | The inputs for this phase are | The output to this phase is | All Requirements Review is |
| | considerations made for the coordination | the contracted work needing | that the requirements are | to be conducted amongst the |
| | of engineering work amongst the | to be mapped to requirements | mapped out in the SRD and | development team. Upon |
| | development team, the other engineering | amongst the development | RTM. In addition the Safety | completion, the information |
| | disciplines, and all subcontractors. | team and the subcontractors. | Engineering Hazard Review | is to be submitted via the |
| | | | (SEHR) is to be completed | online link provided in this |
| | | | online. This review provides | tool. PEER REVIEW |
| | | | insight into the potential for | ONLINE SUBMITTAL. |
| | | | hazard from the requirement | |
| | | | development. | |

| Verification | Validation | Changes | Milestone | DocsRequired | Revision |
|---|---|---|---|---|---|
| The EPMs ensure that | The customer may | Changes to revision | Support the EPM in | There are no documents that | The EPM is responseible for |
| the departments are | informally or | controlled | the completion of | are the direct responsibility | coordinating the |
| clear on all work | formally review | configuration items | Milestone # S52. | of the EPMs and TPMs. | Development Team in the |
| package details. | the requirements | will follow the | | | creation of the Requirements |
| | documents created | company approved | | | Phase. |
| | during the phase. | change process. | | | |
| | These activities | | | | |
| | are the | | | | |
| | responsibility of | | | | |
| | the Project Leader | | | | |
| | but require the | | | | |
| | support from the | | | | |
| | Development | | | | |
| | team. | | | | |
| Verification activities | Validation for this | Changes to the | MILESTONE | <a | The EPM is responsible for |
| for this phase are that | phase is defined as | reported milestones | TEXT | href = &quot;/CMMdocs/US | coordinating the |
| the Process Assurance | that Process | are recorded and | | PS SMTP | Development Team in the |
| team will randomly | Assurance records | archived as part of | | Template.doc&quot; | creation of the Requirements |
| audit completed | (or archives) all | the Quality | | title = &quot; SMTP | Phase. |
| milestones&#044; and | completed | Deliverables of the | | Template&quot;> | |
| perform the document | milestones and | project. | | SMTP</a> | |
| reviews of all of the | reports on their | | | | |
| project deliverable | completion to | | | | |
| documents. | leadership. | | | | |
| The EPMs ensure that | The customer may | Changes to revision | MILESTONE | SRD<br>RTM | The EPM is responsible for |
| all engineering | informally or | controlled | TEXT | | coordinating the |
| departments and | formally review | configuration items | | | Development Team in the |
| subcontractors are | the Requirements | will follow the | | | creation of the documents. |
| clear on all work | documents created | company approved | | | |
| package details and | during the phase. | change process. | | | |
| conducts the | Ensuring that the | | | | |
| Requirements Peer | documents are | | | | |
| Review. In addition, | ready for release is | | | | |
| the EPM is responsible | the responsibility | | | | |
| for ensuring that the | of the EPM, but | | | | |
| Subcontractors are | requires support | | | | |
| staying on schedule | from the entire | | | | |
| and should involve | development team. | | | | |
| them in reviews as | | | | | |
| possible. | | | | | |

| id Source | Plan | Inputs | Outputs | Reviews |
|---|---|---|---|---|
| 18 | The planning for the Requirements phase | The input to the Requirement | The output of the phase is | A Requirements Review is to |
| Developer | includes considerations for the necessary | phase is the customer | that all engineering | ve conducted amongst the |
| | time to thoroughly read the SOW and to | supplied SOW and the | requirements found in the | development team. Upon |
| | assist the EPM in the completion of the | guidelines set by the Planning | SOW are mapped to the | completion&#044; the |
| | Requirements documents. These | documents. | development team | information is to be submitted |
| | documents are the responsibility of the | | Requirements documents. | via the online link provided in |
| | EPM but require support from the | | This is to ve done in the | this tool. PEER REVIEW |
| | Development ream. It is the responsibility | | RTM. | ONLINE SUBMITTAL |
| | of every development team member to be | | | |
| | aware of the information in the | | | |
| | Requirements documents and to Design to | | | |
| | the guidelines set therein. | | | |
| 25 Project | Planning for the Requirements phase | The input to the Requirement | The output of this phase is | A Requirements Review is |
| Lead | includes considerations made for determining | phase is the customer supplies | that the SOW requirements | to be conducted amongst the |
| | how the SOW driven requirements will be | SOW and the guidelines set | will be enumerated in a | development team. Upon |
| | spelled out into the future design. One of | by the Planning documents. | Requirements Trace Matrix. | completion&#044;the |
| | the primary activities of the phase is to | | The RTM is either part | information is to be |
| | enumerate the requirements in the RTM | | of an overall requirements | submitted via the online |
| | so that each requirement can be tracked | | document or standalone. In | line provided in this tool. |
| | against its future design. | | addition the Safety | PEER REVIEW ONLINE |
| | | | Engineering Hazard review | SUBMITTAL |
| | | | (SEHR) is to be completed | |
| | | | online. This review | |
| | | | provides insight into the | |
| | | | potential for hazard from the | |
| | | | requirement development. | |

| Verification | Validation | Changes | Milestone | DocsRequired | Revision |
|---|---|---|---|---|---|
| The verification of the | The customer may | Changes to revision | Support the EPM in the | SRD<br>RTM | The EPM is |
| Requirement documents | informally or formally | controlled configuration | completion of Milestone | | responsible for |
| is conducted via the | review the Requirements | items will follow the | #S52. | | coordinating the |
| EPM led Requirements | documents created | company approved | | | Development Team |
| Peer Review activities. | during the phase. | change process. | | | in the creation of the |
| | Ensuring that the | | | | Requirements Phase. |
| | documents are ready for | | | | |
| | release is the | | | | |
| | responsibility of the | | | | |
| | EPM&#044; but | | | | |
| | requires support from the | | | | |
| | entire development team. | | | | |
| The verification of the | The customer may | Changes to revision | MILESTONE TEXT | SRD<br>RTM | The EPM is |
| Requirement documents | informally or formally | controlled configuration | | | responsible for |
| is conducted via the EPM led | review the Requirements | items will follow the | | | coordinating the |
| Requirements Peer Review | documents created | company approved | | | Development Team |
| activities. | during the phase. | change process. | | | in the creation of the |
| | Ensuring that the | | | | Requirements Phase. |
| | documents are ready for | | | | |
| | release is the | | | | |
| | responsibility of the | | | | |
| | EPM&#044; but | | | | |
| | requires support from the | | | | |
| | entire development team. | | | | |

Variable data files 110 include QRS (Quality Records Submission) or milestone file 120, an edit log 122, a schedule file 124 for each discipline involved in the project, and optionally an archive log (not shown) that tracks revision history of all forms used by the program (name of form, version and date or revision). Milestone file 120 contains a record of milestone completion for the selected project, and optionally other data such as peer review completion records, and hazard information completion records. These are not actual copies of the content of these items, but an electronic checklist of what has been completed in each.

In a preferred embodiment, access to the different files and program functions can be limited for a given individual or position depending on that person's role and discipline and project. For example, access to the schedule file 124 for the purposes of changing target completion dates may be limited to the program manager to insure the integrity and security of the file content.

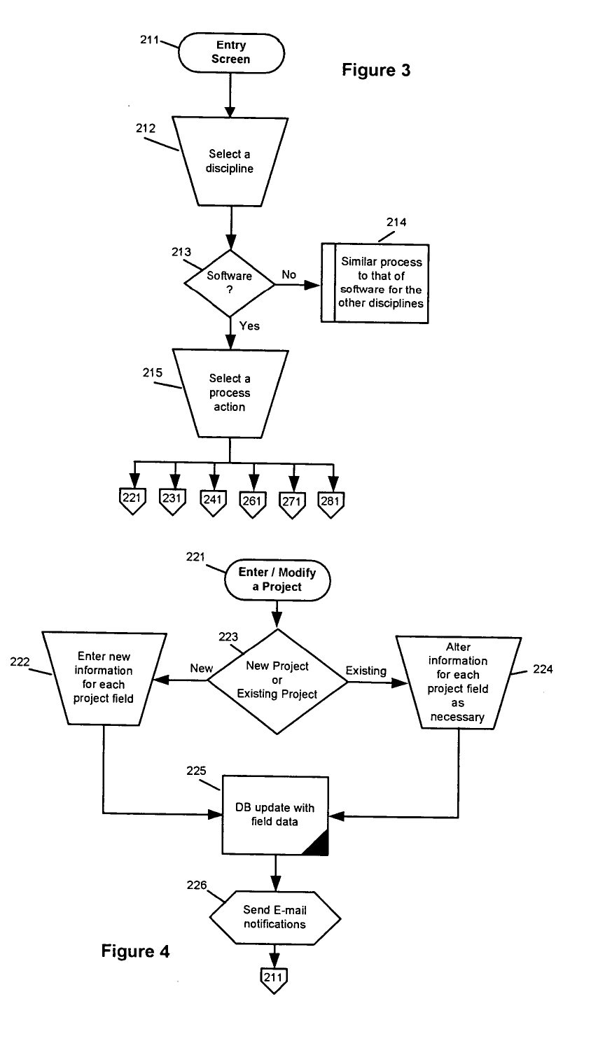

Turning now to FIG. 3, the system entry screen is accessed through the use of a series of interactive windows or templates displayed on user terminal or computer 112, which allow a user to interface with the system. The displayed screens are preferably in html format to permit user access with a web browser.

Display of an entry screen (step 211) is the point at which several choices can be made to direct the user to an activity needing to be performed. The initial activity to be completed on the entry screen is the determination of the engineering discipline (step 212). In this example, the software discipline is chosen (step 213). However, other engineering disciplines such as firmware, electrical, mechanical, etc. can be selected (steps 214) using a similar approach to options with consideration taken to focus on the requirements of that particular discipline. Upon choosing the software discipline, the tool presents a selection screen allowing multiple differing activities for the user (step 215).

Choices for the user include: “Enter a new project into the system” 221, “Completing the Software Quality Assurance Plan” 231, “Reporting completed activities” 241, “Reviewing the process flow that the project is using” 261, “Viewing an external database” 271, and “Accessing the tools section” 281. The selection of one of the aforementioned choices is made via a selection button. Finally, the user has a choice to either “continue” (accept the choices made), or “reset” (clearing the input screen) and start over with the selection criteria. Optionally there are two other features on the entry screen, (1) online tutorial assistance, and (2) a continuously scrolling corporate policy mandating the use of the tool (this was created to assist in the completion of the requirements of CMM).

Option screen 221, depicted in FIG. 4, is used by project leaders to get a new project added to the system database or edit an existing project. The first criterion is for the project leader to decide (step 223) if the project is new, or an existing project is being modified. If the project is new, then the project leader needs to enter the information for each field required and submit the data (step 222). Information needed includes the Customer Cost Quote (CCQ)/project number, the CCQ/project description, the project type from its associated drop down box of choices, the program manager (PM) email address (used for communicating with the PM), the engineering program manager (EPM) email address (used for communicating with the EPM), and the project work space name (used for monitoring the files of the project to compliance). If the project is simply being modified or updated and not new to the system, then the project leader should alter only the necessary information required to provide the changes made (step 224). In addition to the aforementioned contact information and project characteristics, the EPM is required to provide a tentative schedule of the completion dates for the project phases. The project leader is next required to provide the tentative schedule for the development phases, and the activity is completed by using the “submit” button (step 225). After submission of the data, the project leader will receive email notification of the data being entered into the tool (step 226).

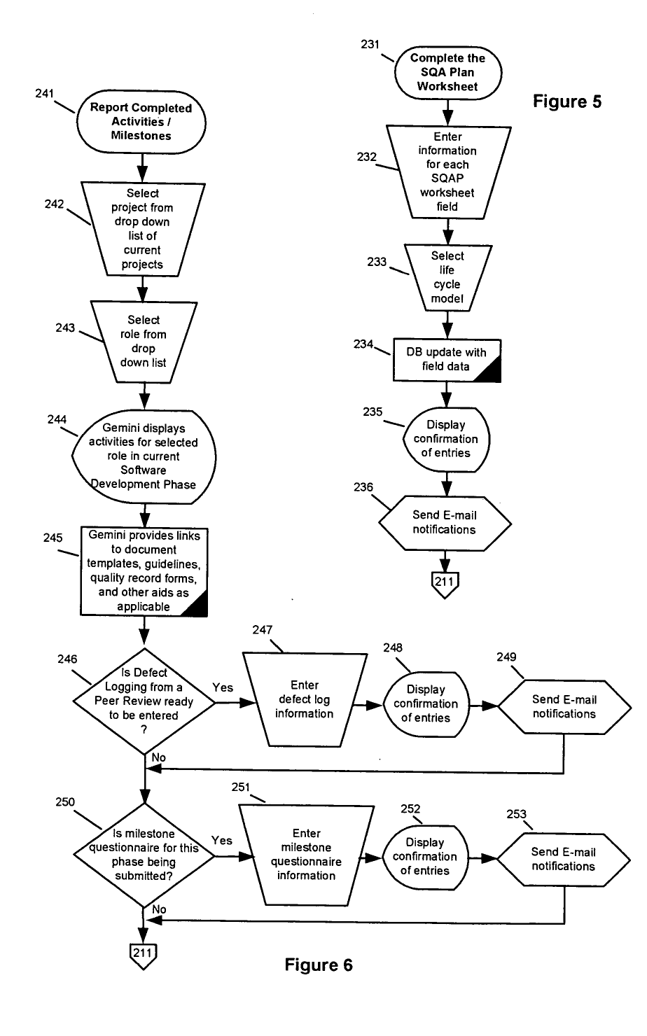

Turning next to “Completing the Software Quality Assurance Plan” 231 depicted in FIG. 5, the information needed for the SQAP includes the project leader's requirement to size the complexity of the project effort (step 232). This sizing is performed by the completion of a series of complexity questions that determine the work level size for the project. The intended result is that a project is required to perform no more quality related activities than has been found is to be necessary in order to ensure that the project is monitored to compliance. This is done to ensure that small projects are not hampered by overbearing activities that prevent the effort from being successful. The complexity scoring questions include: the subdivision that the project is being led by; the experience level of the people working the requirement changes for the project; the level of coordination required for the project; have similar system requirements been implemented before; what is the estimated level of difficulty on the requirements of the system; what is the expectation of the percentage of changes to the requirements; what is the estimated level of risk to implement all requirements; what is the effort level; who is the software project leader; and is the project an R&D effort. The other main requirement for the project leader is to tailor the process life cycle to one that most closely resembles the one being used by the project (step 233). This CMM required activity allows the project leader choices between the “waterfall” (where all requirements are completed in one cycle), “incremental” (where a selected set of the requirements is completed in each cycle), or “evolutionary” (where all of the requirements are completed and each cycle is used for refinement). Finally, as before, the submit button (step 234) is used to update the database fields and provide a display of the changes (step 235). After submission of the data, the project leader will receive an automated email confirmation of the completed SQAP (step 236).

Turning next to “Reporting completed activities” 241, as depicted in FIG. 6, this is the default location for activities to begin. It is the area of the tool where most of the users perform their activities and report the completion of their milestones. First, assuming that the project has already been entered into the system, the user selects their specific project from the drop down box (step 242). Second, the user selects their role in the project (step 243); the process will be tailored to the actual role of the person performing the activity. The user will now see all of the required activities for that particular role and phase of development (step 244). The display is generated from the fixed data files 108 of the form shown in Table 1 above. The description is worded to meet the requirements of the applicable CMM and ISO standards. The user is brought by default to the current phase, but other phases can be selected. This display includes links to document templates, guidelines, quality record forms, and other aids which the user can follow (step 245).

Depending on the phase of development, the user may be asked to complete a peer review. A peer review is an inspection of the completed work product, either source code and/or documentation, by several members of the engineering community. The minimal requirement for the peer reviews is that the team performs them during the Requirements, Design, and Development (RDD) phases. Upon completion of the review (step 246), the moderator of the review enters the defect log information into the database (step 247). By submitting the data a display of the entries is provided (step 248) and an email notification is sent to the Software Quality Assurance (SQA) department (step 249).

After all activities are completed in the phase, the project leader is required to complete a milestone activity, confirming the completion of the phase (step 250). The milestone is a questionnaire that is created by SQA, and that is completed and submitted by the project leader (step 251) after completing all of the necessary activities in the phase. The tool displays the information being sent to SQA for confirmation (step 252) and sends an email notification of the completion (step 253).

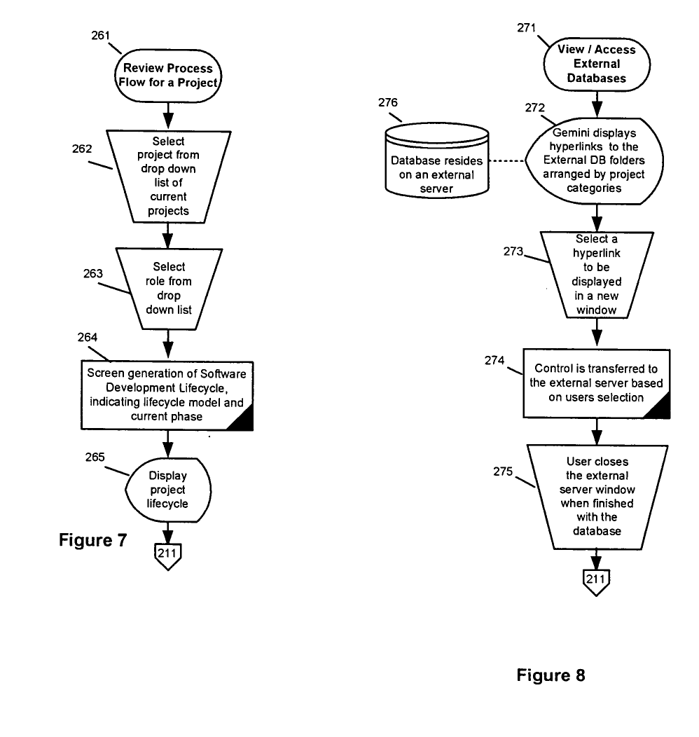

Turning next to “Reviewing the process flow that the project is using” depicted in FIG. 7, the system allows a user the ability to see the process flow for their specific project (step 261) without accessing the screen where the completed milestones and templates are located. The user first selects their specific project from a drop down list of all current projects in the system (step 262). Next, the user selects the role that appropriately describes their responsibility in the project (step 263). Upon submission by the user, the system will generate a view of the software development life cycle (step 265) and the current phase of development for the project (step 264).

Turning next to “Viewing an external database” depicted in FIG. 8, the system provides the user an option 271 to access to multiple external databases residing on an external server 276. Currently, several databases are accessible: the process asset library repository of guidelines, templates, and process related documents; the historical database repository of previously completed project documents that includes completed planning documents, estimates, risk lists and schedules; and information for the company driven Measure to Optimize Value system (MOVE). The MOVE system is used by departments to support and generate activities in cost reduction, sales increase and asset management. Each external database screen provides the user with information about the system's intent and purpose. Access is created as the tool provides hyperlinks to prearranged folders on the company document repository (step 272). The user first selects a hyperlink that will provide the user with the information desired. As the user selects the hyperlink, a new window is created (step 273) and control is transferred from the tool to the repository (step 274). The user now has full access to the contents of the folder. When the user has completed his activities and no longer needs access to the folder, the user simply closes the folder and the opened window (step 275).

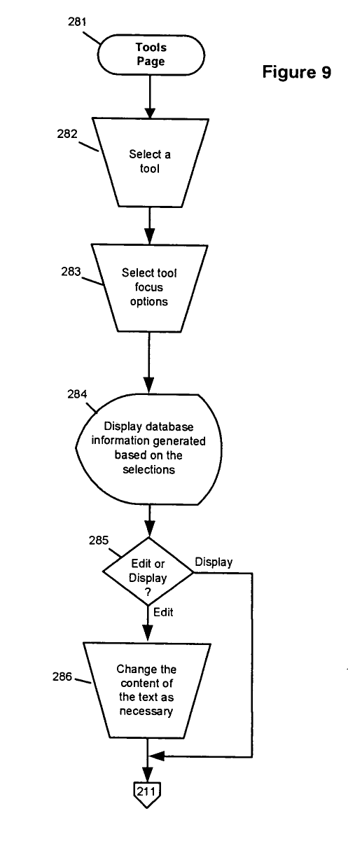

Turning next to use of the “tools page” as depicted in FIG. 9, the system provides the user access to a variety of tools (step 281). The user selects the desired tool (step 282) and specific tool options (step 283). The user is presented with a display generated based on the selections chosen (step 284). Currently, tools provided include: Software Development Process (SDP) tracking, project milestone tracking, content editing, milestone editing, and SDP editing. SDP tracking provides the user access to a display of the milestones that have been completed, the dates of the completed Software Quality Assurance Plans, the dates of the completed peer reviews and their results, and the dates of the completed software engineering hazard review for each project. Project milestone tracking provides the user with the dates of the completed project specific milestones, including a roll-up of the milestone completion information by the engineering discipline chosen. The user can also see a roll-up of all of the milestones completed for a project by roles.

If an editing option is chosen (decision 285), the system displays the selected information in a format that can be modified (step 286). The content editor displays the current text for a process based on selections of discipline, project type, role, and development phase. The user can make changes to the fields as needed. The milestone editor displays the current text for a process phase milestone questionnaire (based on selections of discipline, project type, role, and development phase); the user can make changes to the questionnaire as needed.

The SDP editor tool provides the user with a variety of options to perform on the tool databases. Based on the tool selections, the user can be presented with displays of the edit log for the selected type of project; the mandatory process requirements for the various work levels of the SQA Plan; a typical work breakdown structure for the selection; a report of all on-line training activity; or a page that takes the user to the “Add/Modify a Project” screen 221.

The SDP Editor also provides the user with the option to dump a process database, converting the SQL database into a spreadsheet format. The system then opens the spreadsheet in another window. The user can then access and process the spreadsheet as necessary. Finally, upon completion of review, the user simply closes the spreadsheet window.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is, therefore, intended that the appended claims encompass any such modifications or embodiments.

1. A method for computer-implemented management of a project using project management software, which project is defined by a series of development phases, and wherein each development phase of the project must be evaluated by one or more predetermined standards, each of which standards defines a set of quality assurance steps in order to achieve compliance with the standard for each phase, comprising the steps of
selecting one of the development phases;
displaying a reporting screen containing reporting instructions for the selected development phase, which instructions relate to compliance with the quality assurance steps for that phase according to at least one of the standards;
inputting reporting information concerning the selected development phase; and
saving the reported information concerning the selected development phase.

2. The method of claim 1, wherein the instructions ask if one or more documents relating to compliance with one or more of the quality assurance steps for that phase were completed.

3. The method of claim 1, further comprising:
selecting a user role; and
displaying a description of what a user having that role should do during the selected phase for each quality assurance step to comply with one of the predetermined standards.

4. The method of claim 3, wherein the displayed description comprises composite instructions meeting two or more predetermined standards.

5. The method of claim 4, wherein the predetermined standards comprise ISO and CMM standards.

6. The method of claim 1, wherein saving the reporting information comprises emailing the reporting information to a quality assurance entity.

7. The method of claim 1, wherein saving the reporting information comprises saving a copy of the reporting information to a data storage medium.

8. The method of claim 3, wherein the description lists one or more documents required to be completed to satisfy a quality assurance step for the selected development phase.

9. The method of claim 8, wherein the listed document comprises a hyperlink to the required form.

10. The method of claim 3, wherein the displayed description comprises a table having separate entries for each of planning activities preceding the project phase, phase inputs, phase outputs, peer reviews, verification results, validation results, and procedures for handling changes made during the phase.

11. The method of claim 1, further comprising:
maintaining as a data file stored on a data storage medium a file containing target completion dates for each phase of the project; and
displaying graphically the phases completed, phases not yet completed and past target completion date, and phases not yet completed not yet past target completion date.

12. The method of claim 1, wherein users at different locations access the project management software through a network.

13. A computer-implemented system for management of a project, which project is defined by a series of development phases, and wherein each development phase of the project must be evaluated by one or more predetermined standards, each of which standards defines a set of quality assurance steps in order to achieve compliance with the standard for each phase, comprising:
a host computer;
a database stored on data storage media accessible to the host computer, the database having discrete records containing information concerning state of completion of the project; and
project management software executable on the host computer having program logic for selecting one of the development phases, displaying a reporting screen containing reporting instructions for the selected development phase, which instructions relate to compliance with the quality assurance steps for that phase according to at least one of the standards, inputting reporting information concerning the selected development phase, and saving the reported information concerning the selected development phase.

14. The system of claim 13, wherein the project management software includes a network interface whereby users can remote access the project management software through a network.

15. The system of claim 14, wherein user screens for entering and displaying information with the project management software are accessible as html pages.

16. The system of claim 13, wherein the database comprises a milestone file of indicators, which keep track of completion of development phases.

17. The system of claim 16, wherein the database further comprises a schedule file containing target completion dates for each phase of the project, and the project management software further contains software that displays graphically development phases completed, phases not yet completed and past target completion date, and phases not yet completed not yet past target completion date.
